(19) United States
(12) Patent Application Publication
(10) Pub. No.: US 2024/0387899 A1
(43) Pub. Date: Nov. 21, 2024

(54) SELF-REGULATING COOLING DEVICE FOR AN ENERGY STORAGE, COOLING ARRANGEMENT, ENERGY STORAGE AND MOTOR VEHICLE

(71) Applicant: AUDI AG, Ingolstadt (DE)

(72) Inventors: Paul FRANK, Oedheim (DE); Carsten LORENZ, Reichertshofen (DE); Eduard MAIN, Buxheim (DE)

(73) Assignee: AUDI AG, Ingolstadt (DE)

(21) Appl. No.: 18/651,854

(22) Filed: May 1, 2024

(30) Foreign Application Priority Data
May 15, 2023 (DE) 102023112709.8

(51) Int. Cl. H01M 10/637; H01M 10/613; H01M 10/617; H01M 10/625; H01M 10/6556

(52) U.S. Cl. CPC H01M 10/637; H01M 10/613; H01M 10/617; H01M 10/625; H01M 10/6556; H01M 2200/101

(57) ABSTRACT

A cooling device for an energy storage, which has multiple cooling channels through which a coolant can flow and an adjusting device which includes at least one temperature-dependently adjustable adjusting element, through the adjustment of which a flow characteristic of at least one of the cooling channels can be changed. The cooling device is designed as an inter-cell cooling element for arrangement in an intermediate space between a first and a second storage cell of the energy storage. Through the displacement of the at least one adjusting element the flow characteristic of at least one first of the cooling channels can be changed with respect to a second of the cooling channels.

### FIELD

The invention relates to a cooling device for an energy storage, which has a plurality of cooling channels through which a coolant can flow, and which has an adjusting device which comprises at least one adjusting element which can be passively adjusted as a function of temperature, wherein a flow characteristic of at least one of the cooling channels can be changed by adjusting the at least one adjusting element. Furthermore, the invention also relates to a cooling arrangement having such a cooling device, and a motor vehicle.

### BACKGROUND

Cooling devices for energy storages are known from the prior art. If different regions of an energy storage have different temperatures, it would be desirable to be able to operate a cooling device such that it is adapted thereto.

In this context, DE 10 2020 125 656 A1 describes an energy storage for a motor vehicle with at least one hollow profile in which at least two components designed as storage elements for storing electrical energy or as a fuel cell are arranged. Furthermore, the energy storage comprises at least one first coolant channel running in the hollow profile, through which a coolant can flow for cooling the components, wherein the adjacent components are held at a distance from one another by means of the hollow profile, through which a second coolant channel is formed, which is partially directly delimited by the components and partially directly delimited by the hollow profile, which can be supplied with coolant via the first coolant channel. At least one closing element is arranged in the second coolant channel, by means of which a flow cross section of the second coolant channel through which the coolant can flow can be adjusted. In particular, the closing element can be used to control whether the coolant part located between the components is flowed through by the coolant or not. This is intended to provide cooling according to needs. If one of the components has a higher temperature than the other components, it can be cooled intensively. This is intended to prevent thermal propagation of a thermally runaway storage element.

Nevertheless, the aim to provide even better customization options remains.

### SUMMARY

The object of the present invention is therefore to provide a cooling device, a cooling arrangement, an energy storage and a motor vehicle which enable the most adapted possible cooling of an energy storage.

The invention relates to a cooling device for an energy storage, which has a plurality of cooling channels through which a coolant can flow, and which has an adjusting device which comprises at least one adjusting element which can be passively adjusted as a function of temperature, wherein a flow characteristic of at least one of the cooling channels can be changed by adjusting the at least one adjusting element. The cooling device is designed as an inter-cell cooling element for arrangement in an intermediate space between a first and a second storage cell of the energy storage, wherein the inter-cell cooling element has a first cooling side for arrangement on a first cell side of the first storage cell and a second cooling side for arrangement on a second cell side of the second storage cell, wherein the plurality of cooling channels are arranged between the first and second cooling sides and wherein the flow characteristic of at least a first of the cooling channels can be changed relative to a second of the cooling channels by adjusting the at least one adjusting element.

The invention is based on the finding that inhomogeneous temperatures can occur not only across different battery cells or battery modules within an energy storage, but that a single battery cell or, in general, a single storage cell can also have more or less strongly heated regions. During operation of a battery cell, hotspots, i.e. local hot regions of the individual battery cell, can form. In other words, the heat in a cell, especially during operation of such a cell, is distributed inhomogeneously, and there are correspondingly warmer regions of such an individual cell, which can also be referred to as hotspots. Furthermore, the operation of a cell is limited by the fact that a maximum permissible operating temperature of such a cell must not be exceeded. If, for example, a single cell has a very pronounced hotspot region that has a very high temperature, even though the average temperature of the cell is relatively low, then either the entire cell must be cooled strongly in order to be able to reduce the temperature in the hotspot region, which requires a correspondingly large amount of cooling power that cannot be used in a targeted manner, or the power loss of the energy storage as a whole must be limited, which results in enormous losses in comfort for a user, since this would require, for example, throttling down the power of a motor vehicle. The invention now advantageously makes it possible to adapt the cooling capacity to such locally differently warm regions of an individual cell as required. This is made possible by the inter-cell cooling element described above, which is intended for arrangement in the intermediate space between two such storage cells, and which thus provides multiple cooling channels extending in this intermediate space, the flow characteristic of which can be controlled differently and depending on the temperature, in a particularly efficient manner, namely in a self-regulating, i.e. passive, manner. The change in such a flow characteristic can be provided by the described at least one adjusting element of the adjusting device, which is passively adjustable depending on the temperature. In other words, this adjustable adjusting element can change its adjustment or setting depending on the temperature without the need for an active control option for such an adjusting element. The adjusting element automatically changes its position, extension, length, inclination, geometry or similar depending on the current temperature. Thus, for example, cooling channels or regions of the inter-cell cooling element that border on a hotspot region of a cell and are thus themselves more heated can be more strongly flowed through by a coolant than other regions of the inter-cell cooling element, in which a lower flow of the coolant can be set in a self-regulating manner. The ultimate result is that the cell temperatures of an individual battery cell can be homogenized much better using such a cooling device, which is achieved through the much better adapted cooling. Hotspots in a cell therefore require higher cooling, which is advantageously made possible in a self-regulating manner by the cooling device according to the invention. Warmer and colder regions of a cell are therefore not cooled equally as has been the case up to now, but can advantageously be cooled to different degrees. This means that the real cooling performance can be adapted much better to the actual required cooling performance of a cell.

An energy storage with such a cooling device is also to be considered as part of the invention, as will be explained in more detail later. Such an energy storage can be a battery, for example a high-voltage battery for a motor vehicle. The energy storage can have multiple modules, in particular battery modules. These battery modules can in turn each comprise multiple storage cells, for example battery cells. The battery cells can be formed as lithium-ion cells, for example. The battery cells can be provided, for example, in the form of a cell stack with multiple battery cells arranged next to one another in a stacking direction. For example, such an inter-cell cooling element can be arranged between two battery cells arranged adjacent to each other. The inter-cell cooling element does not necessarily have to be the only cooling option for cooling such cells of an energy storage, but such inter-cell cooling elements can be implemented in addition to other cooling devices of the energy storage, for example a bottom cooling and/or cover cooling of the energy storage.

Cooling battery cells using an inter-cell cooling element also has the great advantage that a particularly large surface area of the battery cells can be cooled. Typically, those sides of a storage cell which face the adjacent cell in a cell stack and which are referred to herein as the first and second cell sides represent the sides of such a storage cell with the largest surface area. By arranging a cooling device in the form of an inter-cell cooling element in the space between two such storage cells, a large part of the surface of such a storage cell can be cooled. In addition, this cooling can now advantageously be provided locally adapted to any temperature differences beyond the surface of the first and second cell sides of the respective first and second storage cells.

Preferably, the inter-cell cooling element is plate-shaped. In other words, the first and second cooling sides of the inter-cell cooling element can be substantially flat and aligned parallel to each other. This means that the inter-cell cooling element is particularly well adapted to the geometry of the space between two storage cells of an energy storage. The inter-cell cooling element further comprises at least two cooling channels, but may also comprise more than two cooling channels.

The cooling channels within the inter-cell cooling element are at least partially spatially separated from each other. The inter-cell cooling element can have a distribution region, which represents a part of the interior of the inter-cell cooling element, which allows a distribution of a coolant to the individual cooling channels. Accordingly, the inter-cell cooling element can also have a collection region, which represents a further partial region of the interior of the inter-cell cooling element, in which the coolant that has flowed through the cooling channels collects shortly before it is discharged again from the inter-cell cooling element. The individual cooling channels can be at least partially spatially separated from one another by separating webs which extend from the first cooling side to the second cooling side. As a result, such separating webs can simultaneously support the first cooling side against the second cooling side. This stabilizes the two cooling sides relative to each other with respect to external pressure forces.

The adjusting device, which is particularly integrated into the inter-cell cooling element, i.e. is located in the interior of the inter-cell cooling element, can generally comprise only a single adjusting element or multiple such adjusting elements. These can be arranged at different positions within the inter-cell cooling element. The descriptions which refer below to at least one adjusting element can therefore equally apply to all other optional adjusting elements.

By means of the at least one adjustable adjusting element, the flow characteristic of the inter-cell cooling element in the space between the first and second storage cells can be adjusted locally differently depending on the temperature, namely by automatic, passive, temperature-dependent adjustment of the at least one adjusting element. The adjusting device can therefore be designed in such a way that, if different temperatures are present in different regions of the space between the two cells, the flow characteristic of the inter-cell cooling element are locally different in these regions.

According to an advantageous embodiment of the invention, this can be achieved in a simple manner if the at least one adjusting element is designed such that the passive temperature-dependent adjustability of the adjusting element is provided by a temperature-dependent change in length and/or volume of the adjusting element. In other words, the temperature-dependent adjustability of the adjusting element can be determined or caused by the temperature-dependent change in length and/or volume of the adjusting element. The adjusting element can therefore adjust itself accordingly due to its temperature-related length and/or volume change, for example length expansion or volume expansion, and thereby locally change the flow characteristic within the inter-cell flow element. As a result, the adjusting element advantageously reacts automatically to temperature changes by also changing its length and/or volume depending on this temperature change and thereby influencing the flow characteristic within the inter-cell cooling element. In principle, a wide variety of materials are suitable as adjusting elements, since many materials exhibit such a temperature-dependent change in length and/or volume, although this can vary in intensity from material to material. For example, the difference in this characteristic between two materials can be used to effect a corresponding adjustment of the adjusting element, as is the case with a bimetallic strip, for example.

Therefore, it represents a further very advantageous embodiment of the invention if the adjusting element is designed as a bimetallic element, for example a bimetallic strip, or has such a bimetallic element. In particular, it is possible that the adjusting element, by being designed with such a bimetallic element, not only uses the bimetallic element as an actuator, but also as an actual adjusting element. In other words, no further element needs to be adjusted via such a bimetallic element, but the adjustment of the bimetallic element enables the change of the flow characteristics of the at least one cooling channel described above. This enables a particularly space-saving design, as no additional elements are required. A bimetallic element is characterized by the fact that it has two material layers made of different metals that are arranged on top of each other. The different metals or alloys that these individual material layers can consist of exhibit different volume and/or length expansion depending on the temperature. In other words, they each have a different coefficient of thermal expansion. When heated, the bimetallic element can be bent in one direction. The basic shape of the bimetallic element can, for example, be flat and elongated or spiral-shaped. Any other structure is also conceivable. This results in numerous possible designs that can be used to influence the flow characteristic within such an inter-cell cooling element. However, the adjusting element does not necessarily have to be designed as a bimetallic element, but can also be designed in another way to provide passive temperature-dependent adjustability. Examples of this are the formation with a shape-memory alloy and/or with a so-called expansion element. Depending on the working temperature, expansion material consists of oil, wax, hard paraffin or even metal. A change in temperature causes a change in the volume of this expansion material. The volume change can be converted into a movement accordingly. The flow can then be regulated, for example, by lengthening or shortening the channels.

In general, different adjustment movements can be provided by the adjusting element depending on its design. When the temperature changes, the adjusting element can, for example, lengthen or shorten, widen, bend, perform a translational movement or a rotational movement or combinations thereof. When arranged within a cooling channel, for example, the adjusting element can narrow or widen the channel cross-section, depending on the temperature.

In an advantageous embodiment of the invention, the adjusting element is provided in the form of a flap and/or a slide and/or a flow guide element. Combinations of these are also possible. In other words, for example, the adjusting device can have multiple adjusting elements, which can be designed differently, both in shape and in their function. This means there are numerous possibilities to locally adjust and influence the flow characteristic of the inter-cell cooling element.

For example, the adjusting element can be assigned to the first cooling channel, so that when the adjusting element is adjusted, the flow characteristics of the assigned first cooling channel are changed. In principle, one such adjusting element can be provided per cooling channel, but this does not necessarily have to be the case. Such an adjusting element can also be provided for every second cooling channel or for a specific subgroup of all cooling channels, etc. If, for example, each of the multiple cooling channels is assigned its own adjusting element, local adjustments to temperature differences can be provided with particularly good spatial resolution.

In a further advantageous embodiment of the invention, the flow characteristic represents at least one of the following: a flow cross-section of the at least one cooling channel through which the coolant can flow, a size or dimension of an inlet opening into the at least one cooling channel and/or an outlet opening from the at least one cooling channel and/or a flow rate and/or a volumetric flow of a coolant flowing through the at least one cooling channel. Through all the characteristic mentioned, it is possible to ensure that some of the cooling channels are more strongly flowed through by the coolant than others if they have different flow characteristic, in particular one of those mentioned above. If the flow cross-section of a cooling channel is reduced, in particular compared to another cooling channel, a smaller amount of coolant will flow through it per unit of time if the same inlet-side fluid pressure or coolant pressure is provided at both of these cooling channels. Different flow cross-sections can in turn be realized by different means, for example by corresponding changes in the size or dimensions of inlet openings in the cooling channels or outlet openings from the cooling channels or also local tapering points within the cooling channels or points that are designed with a changeable local cross-sectional tapering, as can be provided by the adjusting elements described above. Ultimately, this also influences the flow rate in the volumetric flow of the corresponding cooling channels through which the coolant flows during operation of the inter-cell cooling element.

In a further advantageous embodiment of the invention, the adjusting device is designed such that, in the event that in a first region of the inter-cell cooling element in which the first cooling channel is arranged, a first temperature is present which is at least temporarily higher than a second temperature present in a second region of the inter-cell cooling element in which the second cooling channel is arranged, this results in an adjustment of the at least one adjusting element such that, in the event of a coolant flowing through the inter-cell cooling element, the coolant flows through the first cooling channel to a greater extent than through the second cooling channel. In a further advantageous embodiment of the invention, the adjusting device is designed such that, in the event that in a first region of the inter-cell cooling element in which the first cooling channel is arranged, a first temperature is present which is at least temporarily higher than a second temperature present in a second region of the inter-cell cooling element in which the second cooling channel is arranged, this results in an adjustment of the at least one adjusting element such that, in the event of a coolant flowing through the inter-cell cooling element, the coolant flows through the first cooling channel to a greater extent than the second cooling channel.

As an example, the adjusting element can be arranged in front of a corresponding cooling channel in the form of a flap. If it is relatively cool at the location of the adjusting element or if the temperature is within a defined temperature range that is considered to be relatively low, part of the inlet opening of the cooling channel in question can be blocked by the adjusting element. If heating occurs in the region of the adjusting element and this is designed, for example, as a bimetallic strip, the flap provided by the adjusting element can be moved upwards by bending the bimetallic strip. This enlarges the inlet opening for the cooling channel, and a larger volume flow can flow through it. This leads to greater cooling in the region of the adjusting element, which in turn reduces the temperature in the region of the adjusting element. If the temperature drops again accordingly, the flap provided by the adjusting element also closes again accordingly. The transition between different positions of the adjusting element can, depending on the design of the adjusting element, preferably be continuous. Between a maximum closed position and a maximum open position or two otherwise defined extreme positions of the adjusting element, any number of intermediate positions can be defined, which can be taken by the adjusting element during the transition between the two extreme positions or are assumed depending on the current temperature.

This allows the provision of a particularly flexible and well-adapted setting of locally different flow characteristics.

In a further advantageous embodiment of the invention, the inter-cell cooling element has a coolant supply connection for supplying a coolant to the inter-cell cooling element and a coolant discharge connection for discharging the coolant from the inter-cell cooling element, which are arranged in particular in end regions of the inter-cell cooling element that are opposite one another with respect to a first direction. In principle, it is advantageous to provide the inter-cell cooling element with only two connections, namely a coolant supply connection and a coolant discharge connection. Coolant can be fed into the inter-cell cooling element via the coolant supply connection. Through the distribution region within the inter-cell cooling element described above, the introduced coolant can be distributed accordingly to the multiple cooling channels. The flow characteristics through the respective cooling channels are in turn determined by the one or more adjusting elements of the adjusting device, depending on the current local temperature within the inter-cell cooling element or at the location of the respective adjusting elements. Once the coolant has flowed through the cooling channels, it reaches the collection region described above and can be discharged from the inter-cell cooling element again via the coolant discharge connection, namely a central coolant discharge connection. In principle, it is conceivable that the coolant discharge connection and the coolant supply connection are arranged in the same end region of the inter-cell cooling element.

Furthermore, the invention also relates to a cooling arrangement with multiple cooling devices according to the invention or cooling devices according to exemplary embodiments of the invention. The advantages described for the cooling device according to the invention and its embodiments thus apply similarly to the cooling arrangement according to the invention.

Furthermore, it is preferred that the cooling arrangement is designed such that the inter-cell cooling elements are each arranged next to one another in a second direction and at a distance from one another, wherein the coolant supply connections are connected to a common coolant supply line and the coolant discharge connections are connected to a common coolant discharge line. Especially when the coolant supply and discharge connections are arranged on different sides, the connection to a common coolant supply line and coolant discharge line can be made in a particularly simple manner. Nevertheless, this would also be possible if the coolant supply and discharge connections were arranged on the same side of a respective inter-cell cooling element.

Furthermore, the invention also relates to an energy storage for a motor vehicle, which has a cooling device according to the invention or one of its embodiments and/or comprises a cooling arrangement according to the invention or one of its embodiments. Furthermore, it is preferred that the energy storage comprises at least a first storage cell and a second storage cell and that the inter-cell cooling element is arranged in an intermediate space between the first and second storage cells, wherein the first cooling side is arranged on a first cell side of the first storage cell and the second cooling side is arranged on a second cell side of the second storage cell.

The rest of the energy storage can also be designed as already described above. This can have not only two storage cells, but numerous storage cells. For example, the energy storage can comprise one or more battery modules, each with a plurality of battery cells, which can be provided, for example, in the form of a cell stack. In this case, a respective one of the plurality of inter-cell cooling elements can be arranged between each two battery cells of such a battery module arranged adjacent to one another in the cell stack. This enables particularly large-area cooling of the individual storage cells to be achieved, which is also adapted to local temperature differences in individual regions of a cell.

Furthermore, the invention also relates to a motor vehicle having an energy storage according to the invention or one of its embodiments.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a part of a battery module comprising a cooling arrangement according to an exemplary embodiment of the invention;

FIG. 2 shows a schematic representation of a cooling device designed as an inter-cell cooling element according to an exemplary embodiment of the invention.

FIG. 3 shows a schematic representation of the change in the flow conditions in such an inter-cell cooling element according to an exemplary embodiment of the invention;

FIG. 4 shows a schematic representation of an adjusting element for a cooling device according to an exemplary embodiment of the invention;

FIG. 5 shows a schematic representation of an adjusting element for a cooling device according to a further exemplary embodiment of the invention;

FIG. 6 shows a schematic representation of an inter-cell cooling element according to a further exemplary embodiment of the invention.

FIG. 7 shows a schematic representation of an inter-cell cooling element according to a further exemplary embodiment of the invention; and

FIG. 8 shows a schematic representation of the operating principle of an adjusting element for a cooling device according to a further exemplary embodiment of the invention;

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

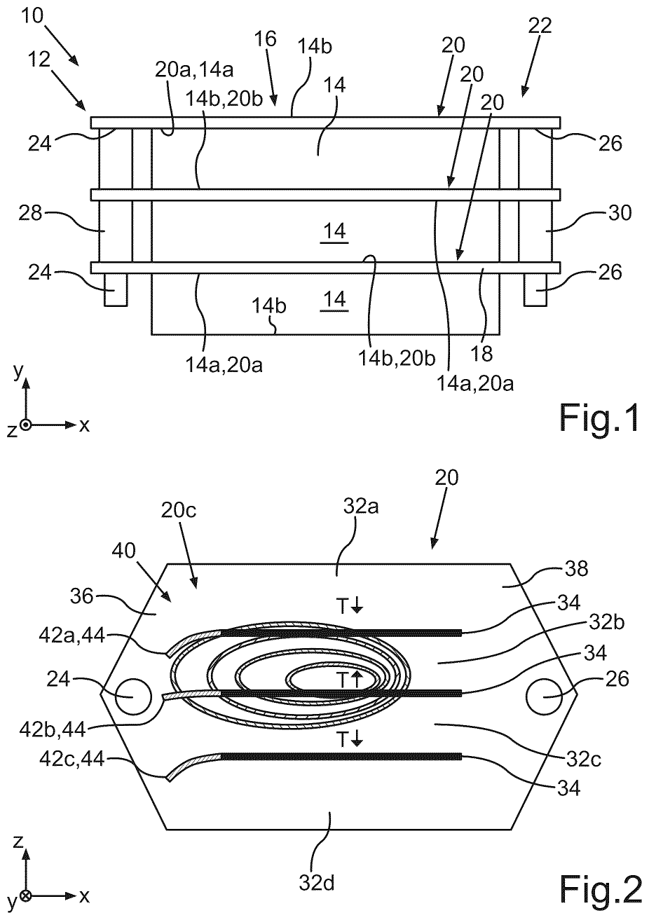

FIG. 1 shows a schematic representation of a part of an energy storage 10 according to an exemplary embodiment of the invention. In particular, a part of a battery module 12 of such an energy storage 10 is shown, for example in a plan view from above, that is to say in the z-direction shown here. In this example, the battery module 12 has a plurality of battery cells 14, which are designed, for example, as prismatic battery cells. Each of these battery cells 14 also has a first cell side 14a and a second cell side 14b, which is opposite the first cell side 14a with respect to the y-direction shown here. The cells 14 are provided in the form of a cell stack 16 and arranged next to each other in the y-direction. The stacking direction therefore corresponds to the y-direction shown here. In the present case, an inter-cell cooling element 20 is arranged in a respective intermediate space 18 between two adjacently arranged cells 14. The inter-cell cooling elements 20 are part of a cooling arrangement 22. Each inter-cell cooling element 20 has a coolant supply connection 24 and a coolant discharge connection 26. A common coolant supply line 28 is connected to these coolant supply connections 24. A common coolant discharge line 30 is also connected to the coolant discharge connections 26. The respective coolant supply connections 24 can, for example, be designed as connection nozzles 24 protruding from both sides of the cooling sides 20a, 20b in and against the y-direction. The coolant discharge connections 26 can also be designed as corresponding nozzles 26. The mutually facing nozzles 24 and 26 can be fluidically connected to one another via line portions, for example pipe sections or hose sections, which in their entirety form the coolant supply line 28 and the coolant discharge line 30, respectively. This allows the individual inter-cell cooling elements 20 to be supplied by a common coolant supply line 28, and the coolant can also be discharged from the inter-cell cooling elements 20 through a common coolant discharge line 30. Each inter-cell cooling element 20 has, as already mentioned, a first and a second cooling side 20a, 20b. The first cooling side 20a is arranged on a first cell side 14a of an adjacent battery cell 14, and the opposite second cooling side 20b is arranged on the second cell side 14b of the neighboring cell 14. Thus, in particular, each cell 14 can be cooled on both sides.

However, the cooling requirement across such a cell side 14a or 14b is not constant. A cell 14 typically has warmer and colder regions. Accordingly, the heat in a cell 14 is not distributed homogeneously. A respective inter-cell cooling element 20 now advantageously allows a local adaptation to the locally different cooling requirements of a respective cell 14. This is explained in more detail below.

FIG. 2 shows a schematic representation of such an inter-cell cooling element 20 in a plan view, for example in the y-direction, as already defined in FIG. 1. More specifically, FIG. 2 shows a schematic representation of the interior 20c of such an inter-cell cooling element 20 to illustrate its structure. Between the first and second cooling sides 20a, 20b described in FIG. 1, multiple cooling channels 32a, 32b, 32c, 32d are arranged in the interior 20c of the inter-cell cooling element 20. The cooling channels 32a, 32b, 32c, 32d are spatially separated from one another, for example by partition walls 34. The partition walls 34 can, for example, connect the first and second cooling sides 20a, 20b described above. Coolant can be supplied to the interior 20c of the inter-cell cooling element 20 via the supply connection 24. The supplied coolant then first reaches a distribution region 36 in the interior 20c and is then distributed to the corresponding cooling channels 32a, 32b, 32c, 32d. The coolant which has passed through the cooling channels 32a, 32b, 32c, 32d accordingly reaches an opposite collection region 38 which is opposite the distribution region 36 with respect to the x-direction. The collecting coolant is again discharged from the interior 20c of the inter-cell cooling element 20 via the coolant discharge connection 26.

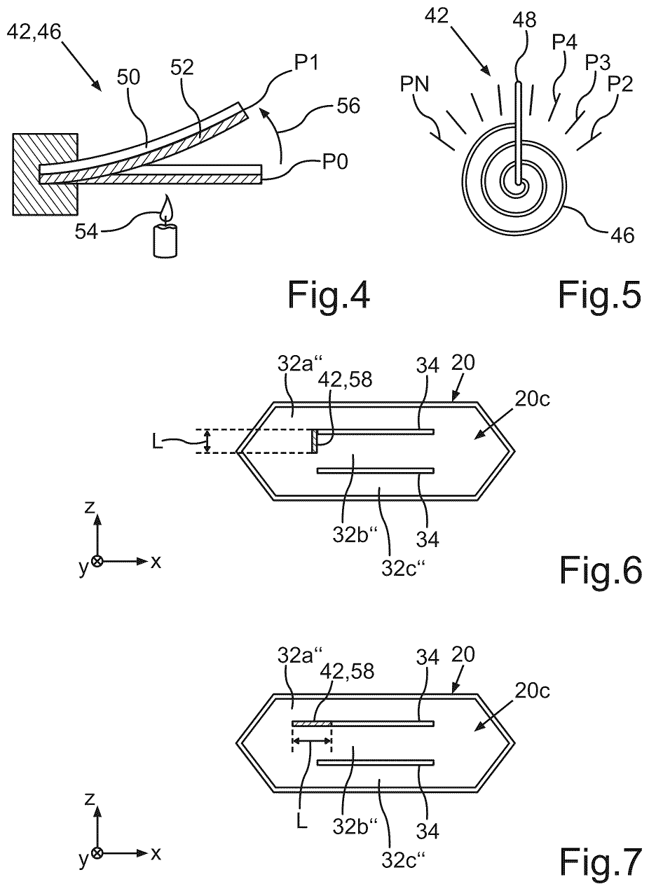

The inter-cell cooling element 20 now advantageously has an adjusting device 40. In this example, this comprises multiple adjusting elements 42a, 42b, 42c. In this example, the adjusting elements 42a, 42b, 42c are arranged on the partition walls 34 for separating the respective cooling channels 32a, 32b, 32c, 32d. These adjusting elements are passively adjustable depending on the temperature. For example, they can be designed as bimetallic strips 46 (see FIG. 4) and deform or bend depending on the temperature T. In this example, the adjusting elements 42a, 42b, 42c are designed as flaps 44. These can enlarge or reduce the inlet opening of the channels 32a, 32b, 32c, 32c depending on the flap position or flap adjustment. By adjusting these adjusting elements 42a, 42b, 42c, the respective flow through a respective cooling channel 32a, 32b, 32c, 32d can be controlled or varied accordingly. In particular, the flow characteristics through a respective cooling channel 32a, 32b, 32c, 32d can be varied and also adjusted differently from one another. The cooling plate provided by the inter-cell cooling element 20, which is arranged in the battery module 12, is correspondingly provided with a plurality of channels 32a, 32b, 32c, 32d, wherein corresponding adjusting elements 42a, 42b, 42c are introduced into these channels, for example in the form of bimetallic strips 46 for providing sliders, flaps or the like. These act as flow controls that adjust the cooling flow, for example, separately for each of the cooling channels 32a, 32b, 32c, 32d. The adjusting elements 42a, 42b, 42c are self-regulating, i.e. the flow regulates itself according to the current temperature T automatically and without active control of the adjusting elements 42a, 42b, 42c. Self-regulation takes place in such a way that at a high temperature T, as in the present example in a central region of the inter-cell cooling element 20, the flow is increased and at a low temperature T the flow is reduced accordingly. This creates a control loop, in particular a self-regulating control loop, in which the temperature T drops again due to increased cooling and thus the flow is reduced again. The cooling plate, i.e. the inter-cell cooling element 20, can have, for example, at least one adjusting element 42a, 42b, 42c per channel 32a, 32b, 32c, 32d or even less, such as a number of adjusting elements 42a, 42b, 42c reduced by 1 of channels 32a, 32b, 32c, 32d, for example if the adjusting elements 42a, 42b, 42c are arranged on the partition walls 34 between the channels 32a, 32b, 32c, 32d. The adjusting elements 42a, 42b, 42c can be arranged at the ends or in the middle of the channels 32a, 32b, 32c, 32d, in particular on the partition walls 34 and/or also within the channels 32a, 32b, 32c, 32d.

In this way, a homogeneous heat distribution within the cells 14 can advantageously be achieved or promoted and hotspots within the cell 14 can be minimized. This also enables better performance and a longer service life, and the cooling can be adjusted to the required cooling performance.

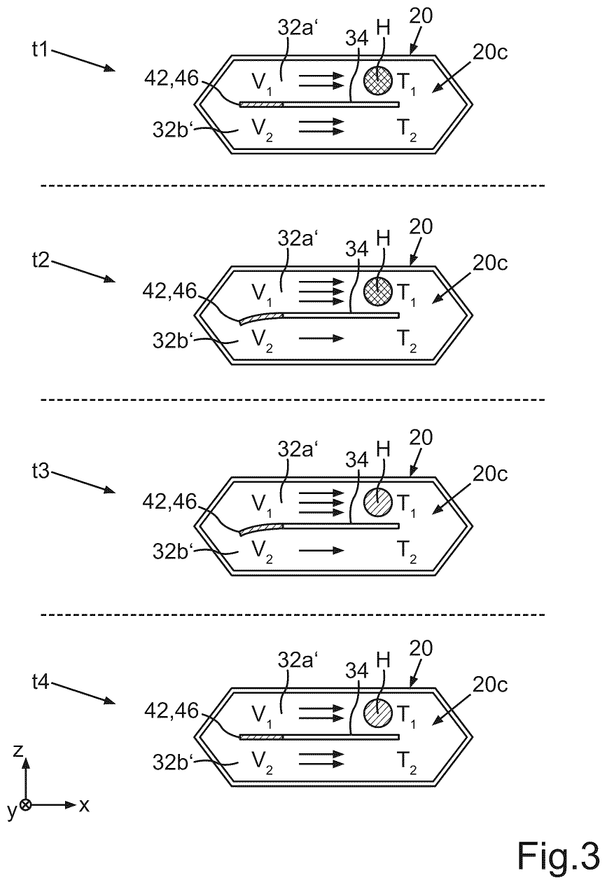

FIG. 3 shows a schematic representation of the change of an adjusting element 42 in a temporal sequence at different successive points in time t1, t2, t3, t4. In FIG. 3 at the top an inter-cell cooling element 20 is again shown, which can in particular be formed as described above and in this simplified representation has for example two cooling channels 32a′, 32b′, which are spatially separated from each other by a partition wall 34, on which the adjusting element 42, for example a bimetallic strip 46, is arranged. The first cooling channel 32a′ is associated with a first volumetric flow V1 and the second cooling channel 32b′ is associated with a second volumetric flow V2. The temperature associated with the first cooling channel 32a′ is designated T1 and the temperature associated with the second cooling channel 32b′ is designated T2. At a first time t1, a region H, which represents a hotspot region at time t1, is located in the first cooling channel 32a′. Accordingly, the first temperature T1 is greater than the second temperature T2 in the second cooling channel 32b′. The adjusting element 42 adapts accordingly, as illustrated in the subsequent second time step t2. It bends downwards like a flap, increasing the first volume flow V1 and reducing the second volume flow accordingly. The adjusting element 42 thus opens from the perspective of the first cooling channel 32a′. As a result, the first cooling channel 32a′ is more strongly flowed through by the coolant and the adjacent regions of the corresponding cells 14 are more strongly cooled. This causes the region H, which represents the hotspot, to cool down. The first temperature T1 has now dropped. This is shown in the third time step t3. The adjusting element 42 then adapts again and returns to the initial length, as illustrated in the fourth time step t4. Now the two volumetric flows V1, V2 of the respective cooling channels 32a′, 32b′ are the same again.

In general, the actuating element provided by the adjusting element 42 opens in the event of a temperature increase in the region of the adjusting element 42. This leads to a higher volumetric flow, whereby the temperature locally drops again, causing the actuating element, namely the adjusting element 42, to close again, which in turn reduces the volume flow. If the temperature rises again, the actuating element opens again and so on.

FIG. 4 shows a schematic representation of a possible embodiment of such an adjusting element 42 for a cooling device 20 according to an exemplary embodiment of the invention. In this example, the adjusting element 42 is designed as a bimetallic strip 46. The bimetallic strip 46 comprises two material layers 50, 52 arranged on top of one another, wherein in this example the first material layer 50 is made of iron and the second material layer 52 is made of copper. In addition, the bimetallic strip 46 is shown in the present example in its initial position P0 and in an adjusted position P1, which it assumes when heating occurs, as is illustrated by the candle 54. When heated, the bimetallic strip 46 bends from the starting position P0 to the bent position P1, since in the present example copper has a larger coefficient of thermal expansion than iron. Arrow 56 illustrates this movement. The extent of movement or bending depends on the amount of temperature change. In this way, the function of a flap 44 can be realized.

FIG. 5 shows a schematic illustration of a further embodiment of an adjusting element 42 according to an exemplary embodiment of the invention. Here too, the adjusting element 42 is again designed with a bimetallic strip 46, which in the present case is designed in the form of a spiral. At the end of this spiral, a flow guide element 48 can be arranged as part of the adjusting element 42. This flow guide element 48 can be made of any material. The bimetallic strip 46 can be designed and operate as described for FIG. 4, and in particular can comprise the two layers 50, 52 described, which, however, are not shown in detail here. When the temperature changes, a corresponding displacement of the flow guide element 48 occurs, in particular according to a rotational movement. The different positions that the flow guide element 48 can assume and cover are designated as P2, P3, P4, PN. The flow guide element 48 can also assume any other intermediate position between these individual illustrated positions P2, P3, P4, PN, depending on the temperature. In particular, the guide element 48 is continuously moved between these positions P2, P3, P4, PN as the temperature changes. The adjusting element 42 can be used or function as a spiral, as a flap opener or flap closer.

FIG. 6 shows a schematic illustration of an inter-cell cooling element 20 according to a further exemplary embodiment of the invention. This can, for example, be designed as previously described, except that the adjusting element 42 in this example is now designed as a slide 58. This can increase or decrease its length L depending on the temperature and thereby influence the volumetric flow of the middle channel 32b″. In this example, the inter-cell cooling element 20 also has three cooling channels, 32a″, 32b″ and 32c″. However, the number of cooling channels can be chosen arbitrarily and independently of the design and arrangement of the adjusting elements.

FIG. 7 shows a schematic illustration of an inter-cell cooling element 20 according to a further exemplary embodiment of the invention. This can be designed, for example, as described for FIG. 6, except that the adjusting element 42, which can also be designed as a slide 58, is arranged in this example with its longitudinal direction parallel to one of the partition walls 34 and not perpendicular to it as in the previously described example. Also this adjusting element 42 can change its length L depending on the temperature and thereby change the length of the channels 32a″, 32b″. In this example, the inlet opening to the upper channel 32a″ can thus be reduced by extending the adjusting element 42 in the x-direction shown here, which also reduces the volumetric flow, while the flow in the second channel below 32b″ is increased.

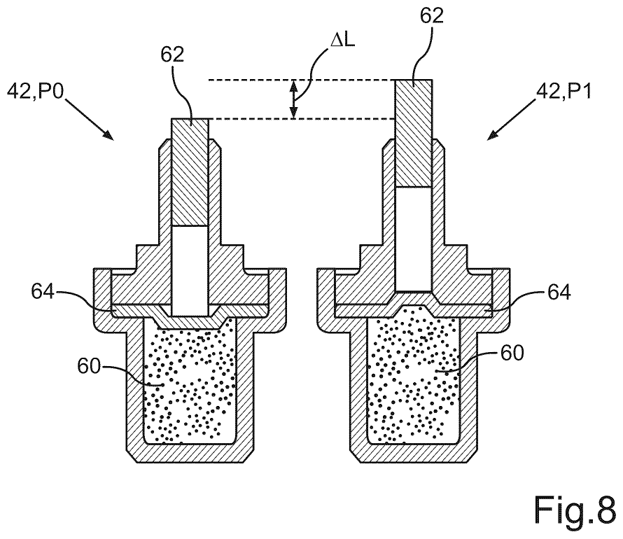

Such adjusting elements 42 in the form of sliders 58 can be provided, for example, with the aid of an expansion material 60, as illustrated in FIG. 8. FIG. 8 shows a schematic representation of the adjusting element 42 in different adjustment states P0, P1. In a first state P0 at lower temperature, the piston 62 is retracted. If the expansion material 60 expands due to an increase in temperature, as shown on the right in FIG. 8, the piston 62 is extended due to the increase in volume of the expansion material 60. This is coupled to the volume of the expansion material 60 via a membrane 64. This consequently results in a stroke ΔL which corresponds to the previously described change in length L (see FIG. 6 and FIG. 7) of the adjusting element 42.

Overall, the examples show how the invention can provide a self-regulating cooling plate.

1. A cooling device for an energy storage, comprising:
a plurality of cooling channels through which a coolant can flow,
an adjusting device which comprises at least one passively temperature-dependently adjustable adjusting element,
wherein by adjusting the at least one adjusting element, a flow characteristic of at least one of the cooling channels can be changed,
wherein the cooling device is designed as an inter-cell cooling element for arrangement in an intermediate space between a first and a second storage cell of the energy storage,
wherein the inter-cell cooling element has a first cooling side for arrangement on a first cell side of the first storage cell and a second cooling side for arrangement on a second cell side of the second storage cell,
wherein the plurality of cooling channels are arranged to extend between the first and second cooling sides, and
wherein the flow characteristic of at least a first of the cooling channels can be changed compared to a second of the cooling channels by adjusting the at least one adjusting element.

2. The cooling device according to claim 1, wherein the at least one adjusting element is designed such that the passive temperature-dependent adjustability of the adjusting element is provided by a temperature-dependent change in length and/or volume of the adjusting element.

3. The cooling device according to claim 1, wherein the adjusting element has a bimetallic element, such as a bimetallic strip.

4. The cooling device according to claim 1, wherein the adjusting element is provided in the form of a flap and/or a slide and/or a flow guide element.

5. The cooling device according to claim 1, wherein the flow characteristic represents at least one of the following:
a flow cross-section of the at least one cooling channel, through which the coolant can flow;
a size or dimension of an inlet opening into the at least one cooling channel and/or an outlet opening from the at least one cooling channel;
a flow rate and/or a volumetric flow of a coolant flowing through the at least one cooling channel.

6. The cooling device according to claim 1, wherein the adjusting device is designed in such a way that, in the event that in a first region of the inter-cell cooling element in which the first cooling channel is arranged, a first temperature is present which is at least temporarily higher than a second temperature which is present in a second region of the inter-cell cooling element in which the second cooling channel is arranged, this results in an adjustment of the at least one adjusting element such that in the event of a coolant flowing through the inter-cell cooling element, the first cooling channel is flowed through by the coolant to a greater extent than the second cooling channel, and/or
the adjusting device is designed in such a way that, in the event that in a first region of the inter-cell cooling element in which the first cooling channel is arranged, a first temperature is present which is at least temporarily smaller than a second temperature which is present in a second region of the inter-cell cooling element in which the second cooling channel is arranged, this results in an adjustment of the at least one adjusting element such that in the event of a coolant flowing through the inter-cell cooling element, the second cooling channel is flowed through by the coolant to a greater extent than the first cooling channel.

7. The cooling device according to claim 1, wherein the inter-cell cooling element has a coolant supply connection for supplying a coolant to the inter-cell cooling element and a coolant discharge connection for discharging the coolant from the inter-cell cooling element, which are arranged in particular in end regions of the inter-cell cooling element that are opposite one another with respect to a first direction.

8. A cooling arrangement with multiple cooling devices, each designed as a cooling device according to claim 1, wherein the inter-cell cooling elements are each arranged next to one another in a second direction and at a distance from one another, wherein the coolant supply connections are connected to a common coolant supply line and the coolant discharge connections are connected to a common coolant discharge line.

9. An energy storage for a motor vehicle with a cooling device according to claim 1, wherein the energy storage comprises at least a first storage cell and a second storage cell and that the inter-cell cooling element is arranged in an intermediate space between the first and second storage cell, wherein the first cooling side is arranged on a first cell side of the first storage cell and the second cooling side is arranged on a second cell side of the second storage cell.

10. A motor vehicle comprising an energy storage according to claim 9.

11. The cooling device according to claim 2, wherein the adjusting element has a bimetallic element, such as a bimetallic strip.

12. The cooling device according to claim 2, wherein the adjusting element is provided in the form of a flap and/or a slide and/or a flow guide element.

13. The cooling device according to claim 3, wherein the adjusting element is provided in the form of a flap and/or a slide and/or a flow guide element.

14. The cooling device according to claim 2, wherein the flow characteristic represents at least one of the following:
a flow cross-section of the at least one cooling channel, through which the coolant can flow;
a size or dimension of an inlet opening into the at least one cooling channel and/or an outlet opening from the at least one cooling channel;
a flow rate and/or a volumetric flow of a coolant flowing through the at least one cooling channel.

15. The cooling device according to claim 3, wherein the flow characteristic represents at least one of the following:
a flow cross-section of the at least one cooling channel, through which the coolant can flow;
a size or dimension of an inlet opening into the at least one cooling channel and/or an outlet opening from the at least one cooling channel;
a flow rate and/or a volumetric flow of a coolant flowing through the at least one cooling channel.

16. The cooling device according to claim 4, wherein the flow characteristic represents at least one of the following:
a flow cross-section of the at least one cooling channel, through which the coolant can flow;
a size or dimension of an inlet opening into the at least one cooling channel and/or an outlet opening from the at least one cooling channel;
a flow rate and/or a volumetric flow of a coolant flowing through the at least one cooling channel.

17. The cooling device according to claim 1, wherein the adjusting device is designed in such a way that, in the event that in a first region of the inter-cell cooling element in which the first cooling channel is arranged, a first temperature is present which is at least temporarily higher than a second temperature which is present in a second region of the inter-cell cooling element in which the second cooling channel is arranged, this results in an adjustment of the at least one adjusting element such that in the event of a coolant flowing through the inter-cell cooling element, the first cooling channel is flowed through by the coolant to a greater extent than the second cooling channel, and/or
the adjusting device is designed in such a way that, in the event that in a first region of the inter-cell cooling element in which the first cooling channel is arranged, a first temperature is present which is at least temporarily smaller than a second temperature which is present in a second region of the inter-cell cooling element in which the second cooling channel is arranged, this results in an adjustment of the at least one adjusting element such that in the event of a coolant flowing through the inter-cell cooling element, the second cooling channel is flowed through by the coolant to a greater extent than the first cooling channel.

18. The cooling device according to claim 1, wherein the adjusting device is designed in such a way that, in the event that in a first region of the inter-cell cooling element in which the first cooling channel is arranged, a first temperature is present which is at least temporarily higher than a second temperature which is present in a second region of the inter-cell cooling element in which the second cooling channel is arranged, this results in an adjustment of the at least one adjusting element such that in the event of a coolant flowing through the inter-cell cooling element, the first cooling channel is flowed through by the coolant to a greater extent than the second cooling channel, and/or
the adjusting device is designed in such a way that, in the event that in a first region of the inter-cell cooling element in which the first cooling channel is arranged, a first temperature is present which is at least temporarily smaller than a second temperature which is present in a second region of the inter-cell cooling element in which the second cooling channel is arranged, this results in an adjustment of the at least one adjusting element such that in the event of a coolant flowing through the inter-cell cooling element, the second cooling channel is flowed through by the coolant to a greater extent than the first cooling channel.

19. The cooling device according to claim 1, wherein the adjusting device is designed in such a way that, in the event that in a first region of the inter-cell cooling element in which the first cooling channel is arranged, a first temperature is present which is at least temporarily higher than a second temperature which is present in a second region of the inter-cell cooling element in which the second cooling channel is arranged, this results in an adjustment of the at least one adjusting element such that in the event of a coolant flowing through the inter-cell cooling element, the first cooling channel is flowed through by the coolant to a greater extent than the second cooling channel, and/or
the adjusting device is designed in such a way that, in the event that in a first region of the inter-cell cooling element in which the first cooling channel is arranged, a first temperature is present which is at least temporarily smaller than a second temperature which is present in a second region of the inter-cell cooling element in which the second cooling channel is arranged, this results in an adjustment of the at least one adjusting element such that in the event of a coolant flowing through the inter-cell cooling element, the second cooling channel is flowed through by the coolant to a greater extent than the first cooling channel.

20. The cooling device according to claim 1, wherein the adjusting device is designed in such a way that, in the event that in a first region of the inter-cell cooling element in which the first cooling channel is arranged, a first temperature is present which is at least temporarily higher than a second temperature which is present in a second region of the inter-cell cooling element in which the second cooling channel is arranged, this results in an adjustment of the at least one adjusting element such that in the event of a coolant flowing through the inter-cell cooling element, the first cooling channel is flowed through by the coolant to a greater extent than the second cooling channel, and/or
the adjusting device is designed in such a way that, in the event that in a first region of the inter-cell cooling element in which the first cooling channel is arranged, a first temperature is present which is at least temporarily smaller than a second temperature which is present in a second region of the inter-cell cooling element in which the second cooling channel is arranged, this results in an adjustment of the at least one adjusting element such that in the event of a coolant flowing through the inter-cell cooling element, the second cooling channel is flowed through by the coolant to a greater extent than the first cooling channel.
